(19) United States
(12) Patent Application Publication
(10) Pub. No.: US 2005/0038720 A1
(43) Pub. Date: Feb. 17, 2005

(54) Method of facilitating the transfer of information relating to livestock and/or food products

(75) Inventor: Martin Andrew Crampton, Berwick (AU)

Correspondence Address: OLIFF & BERRIDGE, PLC, P.O. BOX 19928, ALEXANDRIA, VA, 22320, US

(73) Assignee: NEWBRAIN TECHNOLOGIES PTY LIMITED, Melbourne (AU)

(21) Appl. No.: 10/887,838

(22) Filed: Jul. 12, 2004

Related U.S. Application Data
(63) Continuation of application No. PCT/AU03/00025, filed on Jan. 10, 2003.

(30) Foreign Application Priority Data
Jan. 11, 2002 (AU) PR9916

(51) Int. Cl. G06F 17/60

(52) U.S. Cl. 705/29; 705/26

(57) ABSTRACT

A computer network is used to facilitate the transfer of livestock, stockfeed and/or other food products from a vendor to a purchaser. The vendor initiates a connection over the computer network between a computer associated with the vendor and a computer associated with a transfer facilitator; the transfer facilitator prompts the vendor for information pertaining to the consignment of livestock of food that the vendor proposes to sell; in response to prompts form the transfer facilitator, the vendor provides the transfer facilitator with information regarding the livestock or food which the vendor proposes to sell; and the transfer facilitator converts the information received from the vendor into a vendor declaration and posts the vendor declaration to a point on the computer network associated by the vendor and/or more prospective purchases.

### FIELD OF THE INVENTION

This invention broadly relates to a method of utilising a computer network to facilitate the transfer of livestock and/or food products. The invention relates particularly but not exclusively to a method and system for providing information to prospective purchasers pertaining to a consignment of livestock, stock feed or other food being sold by the vendor.

### BACKGROUND TO THE INVENTION

With the recent increase in instances of contamination entering the food chain it is now more important than ever to monitor the quality of food being sold. A prospective purchaser of foodstuffs must be particularly vigilant to ensure that the foodstuffs they purchase are of a sufficient quality. While a visual inspection of the product being bought is helpful, there are many diseases and chemical contaminations that cannot be identified by a visual inspection.

The considerations that apply to the sale of livestock can also be generally taken as applying to other foodstuffs including the fodder that is purchased to feed livestock. A practice has developed in Australia and other countries of vendors suppling prospective purchasers with information regarding the conditions in which the livestock and fodder and other foodstuffs have been bred and grown. To use livestock as an example, the vendor supplies this information by completing and signing a written declaration pertaining to the history of the livestock. Prospective purchasers can then ask to view the declaration to satisfy themselves as to the condition of the livestock before committing themselves to the purchase.

The completion of these declarations in a paper form is particularly cumbersome and time consuming. Typically, when completed and signed, the declaration is provided to the auctioneer or agent of the vendor as well as any prospective purchasers. The filling out of a form by the vendor and provision of paper copies to the parties involved in the transaction is cumbersome and time consuming. This existing process also fails to ensure that the form is completed before being submitted.

In some instances one or more of the parties to the transaction are required to keep the forms for a pre-determined period of up to two years. Where this is the case, the vendor has the burden of keeping a paper copy of the declaration to be produced when required.

In short, currently available methods and systems for providing information about the livestock being sold are time consuming and cumbersome. Use of the paper system of the prior art also tends to result in inaccurate or incomplete declarations.

An object of the present invention is to provide an alternative or improved method of providing information regarding livestock, to a prospective purchaser.

This discussion of the background to the invention herein is included to explain the context of the invention. This is not to be taken as an admission that any of the material referred to was published, known or part of the common general knowledge as at the priority date of any of the claims.

### SUMMARY OF THE INVENTION

In a first aspect the present invention provides a method of utilising a computer network to facilitate the transfer of livestock between a vendor to a purchaser, the method including the steps of:
the vendor initiates a connection over the computer network between a computer associated with the vendor and a computer associated with a transfer facilitator;
the transfer facilitator prompts the vendor for information pertaining to the consignment of livestock that the vendor proposes to transfer;
in response to prompts from the transfer facilitator, the vendor provides the transfer facilitator with information regarding the livestock which the vendor proposes to sell; and
the transfer facilitator converts the information received from the vendor into a vendor declaration and posts the vendor declaration to a point on the computer network accessible by the vendor and/or one or more prospective purchasers.

Preferably, the transfer facilitator is a transfer facilitation site located on the computer network.

The present invention may be used to facilitate the transfer of any suitable type of livestock. The method is particularly suitable to the sale of cattle and sheep. It is also applicable to the transfer of information relating to food and feedstock.

The connection between the vendor and the transfer facilitator may be made over any suitable computer network. The Internet is a particularly suitable network for operation of the present invention. The computers associated with the vendor and the transfer facilitator may be of any suitable computing devices. Particularly suitable computer devices include conventional desktop computers as well as mobile devices such as personal digital assistants and mobile phones having interactive capability.

The transfer facilitator may be a web site located on the Internet which a vendor may log into and subsequently provide the requested information. The transfer facilitator may prompt the vendor for information pertaining to the consignment of livestock in any suitable manner. In a preferred form the vendor is presented with a number of questions pertaining to the consignment of livestock.

The transfer facilitator may also be an independent purchaser's personal computer that is accessible via a distributed network system.

A distinct advantage provided by the method of the present invention is that information pertaining to the transfer of livestock is quickly and easily converted into an electronic format allowing the vendor to supply the information to multiple parties either automatically or with little effort. There is no paper form filling required by the present invention, and no transfer of paper. The vendor declaration is posted on the computer network allowing all parties to the transaction to see the declaration.

The vendor declaration may be in any suitable electronic format. One particularly suitable format is known as portable digital format (PDF).

Preferably, at any time before posting of the vendor declaration, the transfer facilitator verifies the identity of the vendor and accordingly includes within the vendor declaration an electronic signature verifying its authenticity. This provides for an authentication of the information provided by the vendor and allows any prospective purchaser to be confident that the information supplied in the vendor declaration is true and correct. This also allows the method of the present invention to be used with statutory forms which by law require the vendor to sign that the information provided is correct, this signature added using the present invention appropriately authorises the correctness of this information.

In another preferred form of the invention the vendor declaration is posted at a Uniform Resource Locator (URL) on the Internet, the URL is then provided to one or more prospective purchasers. This allows each of the vendor, purchaser and agent to access the vendor declaration before and after the sale. The vendor declaration can be kept at this point for any suitable required period providing a single point of reference for all parties to the transaction.

In an additional or alternative preferred form of the invention the vendor declaration is posted onto a database accessible over the computer network, the database holding a plurality of vendor declarations. The database may then be indexed to hold the information pertaining to previous and pending transfers thereby providing for the efficient organization of the vendors, purchasers and agents information.

The vendor declaration may, additionally or alternatively, be posted by sending it via electronic mail to one or more of the following:
the vendor;
an agent of the vendor;
one or more of the prospective purchasers;
any relevant statutory authority and
a pre-determined third party.

In another optional form, the method of the present invention has the further steps of:
the vendor nominates a third party; and
the transfer facilitator forwards to the third party, via the computer network, an electronic copy of the vendor declaration. Preferably the third party is an agent appointed to sell the livestock on behalf of the vendor. The third party may also be a food assessor, transporter, processor or Government inspector.

The agent may be any suitable party; a particularly suitable party is the livestock realtor or auctioneer appointed to arrange the livestock sale. The agent may also be appointed by any suitable method.

The method may also have the still further steps including:
the vendor appoints a third party;
the third party connects to the transfer facilitator via the computer network;
the third party provides information regarding the livestock sold on behalf of the purchaser; and
the transfer facilitator verifies the identity of the agent and upon verification, the vendor declaration is modified to include information provided by the third party in the vendor declaration.

Preferably, the third party is one or more of: an agent commissioned to sell the livestock; a food assessor; a party providing transport for the livestock; a processor; a market alliance of the purchaser; and a vet.

In another form optional of the invention, the vendor may accept or reject information provided by the third party. This provides the vendor with control over the information being provided. In other situations, it is preferable for third party to have overall control of the information they place within the vendor declaration. For example, where the third party is a food inspector then it can be important that the inspector be free to place the information they consider pertinent into the declaration.

The information contained in the vendor declaration may include any suitable information supplied by the vendor and/or the agent. In a particularly preferred form of the invention the vendor declaration contains one or more of the following types of information:
whether the livestock have been exposed to pre-determined drugs or chemicals;
information pertaining to any quality accreditation of a property on which the livestock has been raised; and
nature of any feed product provided to the livestock
details of the vendor;
details of any agent appointed by the vendor; and
details of any livestock assessors associated with the livestock.

In an especially preferred form all of this information is included within the vendor declaration.

In a second aspect the present invention provides a system, preferably located on a computer network, the system provided to facilitate the transfer of livestock from a vendor to a purchaser, the system including the following components:
access means for allowing the vendor to access the site via the computer network;
means for interrogating the vendor to allow collection of information pertaining to the livestock that the vendor proposes to transfer;
conversion means for converting the information pertaining to the livestock, the information collected from the vendor and converted into a vendor declaration; and
posting means for posting the vendor declaration to a point on the computer network accessible by one or more prospective purchasers.

Preferably, the system includes:
means to verify the identity of the vendor wherein the means to identify operates at any time before posting the vendor declaration; and
means to modify the vendor declaration to include an electronic signature verifying authenticity of the vendor declaration, the means to modify operating after receiving notification from the means to verify that the vendor's identity has been verified.

The vendor declaration may be posted to any suitable location on the Internet. In a preferred form the vendor declaration is posted at a Uniform Resource Locator (URL) on the Internet, the URL is then provided to one or more prospective purchasers.

The system may additionally or alternatively include a database holding one or more of the vendor declarations, one or more of the declarations being posted onto the system by the posting means.

In an optional form of the invention the posting means sends the vendor declaration via electronic mail to one or more of the vendor, an agent of the vendor, one or more prospective purchasers and/or any relevant statutory authority.

In another preferred form the posting means sends the vendor declaration to an agent appointed by the vendor, the system including:
access means for allowing the agent to access the system via the computer network;
means for interrogating the agent for information regarding the livestock sold on behalf of the purchaser; and
agent verification means for verifying the identity of the agent
compilation means for automatically including information provided by the agent in the vendor declaration where the identity of the agent has been verified by the verification means.

Preferably, the invention includes agent verification means whereby the vendor is able to accept to reject information provided by the agent.

The agent verification means may optionally include an electronic signature on the vendor declaration verifying the information provided by the agent.

The vendor declaration may contain one or more or all of the following types of information:
whether the livestock have been exposed to pre-determined drugs or chemicals;
information pertaining to any quality accreditation of a property on which the livestock has been raised;
nature of any feed product provided to the livestock;
number of livestock detailed in the vendor declaration;
sex of livestock detailed in the vendor declaration;
location of livestock detailed in the vendor declaration;
details of the vendor;
details of an agent appointed by the vendor; and
details of any livestock assessor.

In a further alternative or additional form, the system includes a search means for accessing and searching information pertaining to vendor declarations.

Preferably, the transfer facilitator automatically crosschecks the information provided by the vendor.

In one alternative form, at any time before posting the vendor declaration, the transfer facilitator verifies the identity of the vendor. In another alternative form, after verification of the identity of the vendor, an electronic signature verifying authenticity of the declaration is included together with or within the declaration.

In a third aspect of the present invention, there is provided a method of utilising a computer network to provide information pertaining to the suitability of livestock for consumption, the method including the steps of:
a vendor initiates a connection over the computer network between a computer associated with the vendor and a computer associated with a transfer facilitator;
the vendor provides the transfer facilitator with information regarding the livestock which the vendor proposes to sell; and

the transfer facilitator automatically converts the information received from the vendor into a vendor declaration and posts the vendor declaration to a point on the computer network accessible by the vendor and/or one or more prospective purchasers.

In a fourth aspect of the invention, there is provided a method of utilising a computer network to provide information pertaining to the suitability of food for consumption, the method including the steps of:
a food provider initiates a connection over the computer network between a computer associated with the food provider and a computer associated with a transfer facilitator;
the food provider enters information pertaining to food that the food provider intends to sell including information pertaining to the suitability of the food for consumption; and
the transfer facilitator converts the information received from the food provider into a declaration and posts the declaration to a point on the computer network accessible by the food provider and/or one or more prospective purchasers.

In a fifth aspect of the invention, there is provided a method of providing information pertaining to food over a computer network to facilitate the transfer of food from a food provider to a purchaser, the method including the steps of
a food provider initiates a connection over the computer network between a computer associated with the food provider and a computer associated With a transfer facilitator;
the food provider enters information pertaining to food that the food provider intends to sell including information pertaining to the suitability of the food for consumption; and
the transfer facilitator converts the information received from the food provider into a declaration and posts the declaration to a point on the computer network accessible by the food provider and/or one or more prospective purchasers.

Preferably, the transfer facilitator crosschecks the information entered by the food provider to verify the information.

In one form, at any time before posting of the declaration, the transfer facilitator verifies the identity of the vendor. After verification, an electronic signature may then be included with or within the declaration to verify its authenticity.

In another form, the declaration is posted to a database accessible over the computer network, the database holding a plurality of declarations.

Preferably, the declaration contains one or more of the following types of information: whether the food has been exposed to pre-determined chemicals and/or the method of its propagation and growth. For example, whether it derives from genetically modified parentage. The declaration may also include information pertaining to the quality accreditation of a property from which the food originates;

In still another form, the declaration is sent via electronic mail to one or more of (a) the food provider; (b) one or more prospective purchasers; (c) a relevant statutory authority and (d) one or more agents.

The food to which the information relates may be any suitable type of food, for consumption by humans or animals. One particularly suitable type of food is feedstock for animals.

In a sixth aspect, there is provided a food information system located on a computer network, the system provided to facilitate provision of information pertaining to food, the system including the following components:
access means for allowing a food provider to access the system via the computer network;
means for interrogating the food provider to allow collection of information pertaining to food which the food provider proposes to provide, the information including information pertaining to the suitability of the food for consumption;
conversion means for converting the information pertaining to the food into a declaration; and
posting means for posting the declaration to a point on the computer network accessible by one or more purchasers and/or the food provider.

In one particular form of the invention, the transfer facilitator verifies that the declaration is complete. In another form, the invention includes the additional steps of:
the vendor nominates a third party;
the third party connects to the transfer facilitator via the computer network;
the third party provides information regarding the food; and
the transfer facilitator verifies the identity of the third party and upon verification, the declaration is modified to include information provided by the third party.

The vendor may review information provided by the third party and authorises that that information be included within the declaration. One or more persons may connect to the transfer facilitator to authorise the declaration.

### BRIEF DESCRIPTION OF THE DRAWINGS

The invention will hereinafter be described in greater detail by reference to the attached drawings, which illustrate an example forms of the invention. It is to be understood that the particularity of the drawings does not supersede the generality of the preceding description of the invention. In the drawings:

FIGS. 1A, 1B, 1C & 1D are screen captures illustrating the process where the transfer facilitator interrogates the vendor to collect information pertaining to livestock that the vendor proposes to sell.

FIG. 2 is a sample of a vendor declaration containing information pertaining to livestock according to an embodiment of the present invention.

FIG. 3 is a sample of a blank declaration containing information pertaining to commodities.

### DETAILED DESCRIPTION OF THE INVENTION

In invention will now be described with particular reference to the sale of cattle and sheep. The person skilled in the art will be aware that the invention is equally applicable to the sale of a range of other livestock. The invention is also equally applicable to the transfer of food and feedstock.

The present invention assists the vendor in preparing the necessary documents to enable the transfer of livestock, the present invention also assist purchasers in advertising the availability of such livestock for sale or transfer. Where the vendor wishes to prepare this documentation he/she will connect to the transfer facilitator using their computer. In this exemplary embodiment described the transfer facilitator is a conventional web site located on the Internet. The person skilled in the art will however recognise that the present invention can be implemented without the use of a web site, for example, distributed networks can be utilised to communicated without the intermediate of a site.

The invention may provide for authorisation of the vendor, this will provide an additional safety check on the information provided and accordingly allow prospective purchasers to satisfy themselves that the vendor was the party who supplied the information now contained within the declaration. Where the vendor's identity is authorised, this can be done in any suitable manner. One form of authorisation by the system involves registering and being allocated or providing a password to identify the vendor. Upon connection to the transfer facilitator the vendor will be greeted with the front page providing options including the opportunity to register. Alternatively, vendors that have previously registered may choose to continue further into the system and take advantage of the features provided by the invention.

When the vendor has registered and chosen to move further into the system he/she will be presented with an option to prepare a vendor declaration. The vendor declaration may include any suitable type of information about the livestock to be sold. Information that can be particularly pertinent to the sale of livestock includes the breed, sex, whether the livestock have been exposed to pre-determined drugs or chemicals, information pertaining to any quality accreditation of a property on which the livestock has been raised, the nature of any feed product provided to the livestock and the location of the livestock to be sold. This information may be provided either at the option of the vendor or alternatively there may be a legal requirement to provide such information to prospective purchasers.

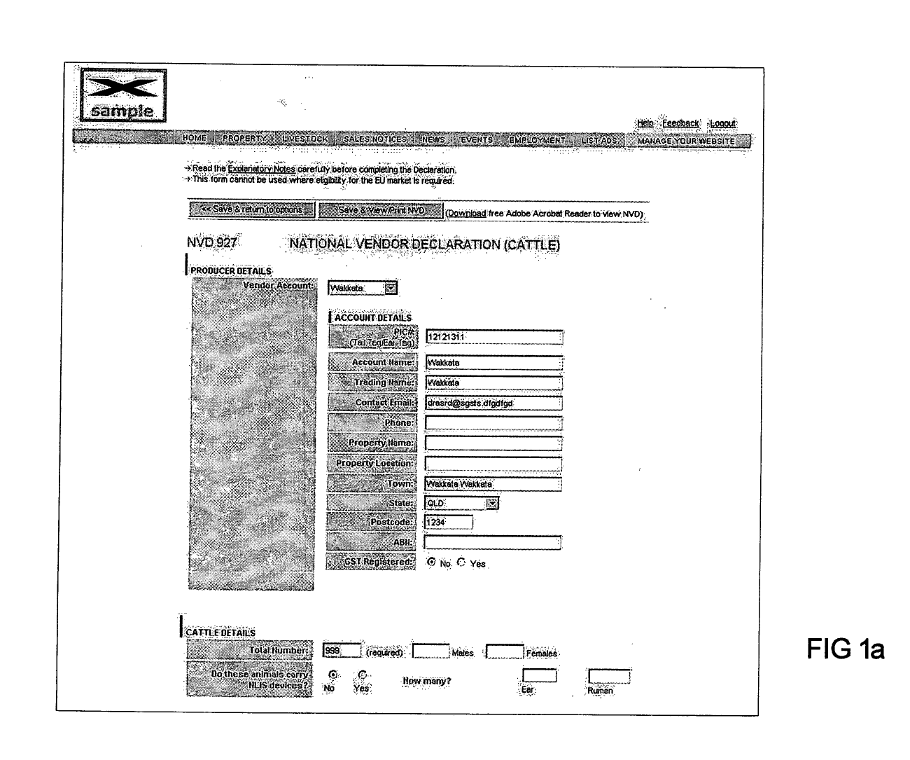

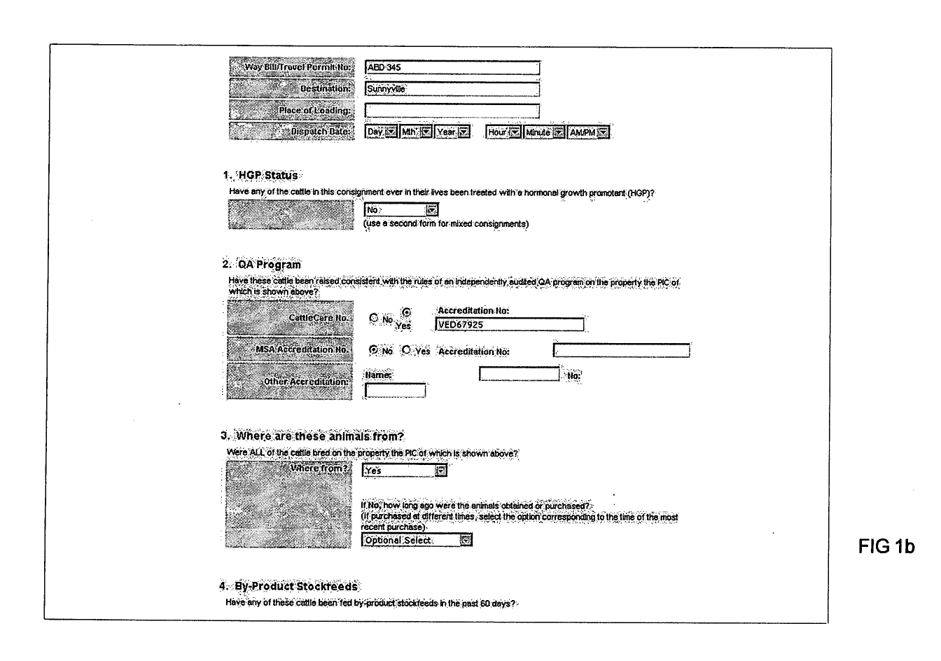

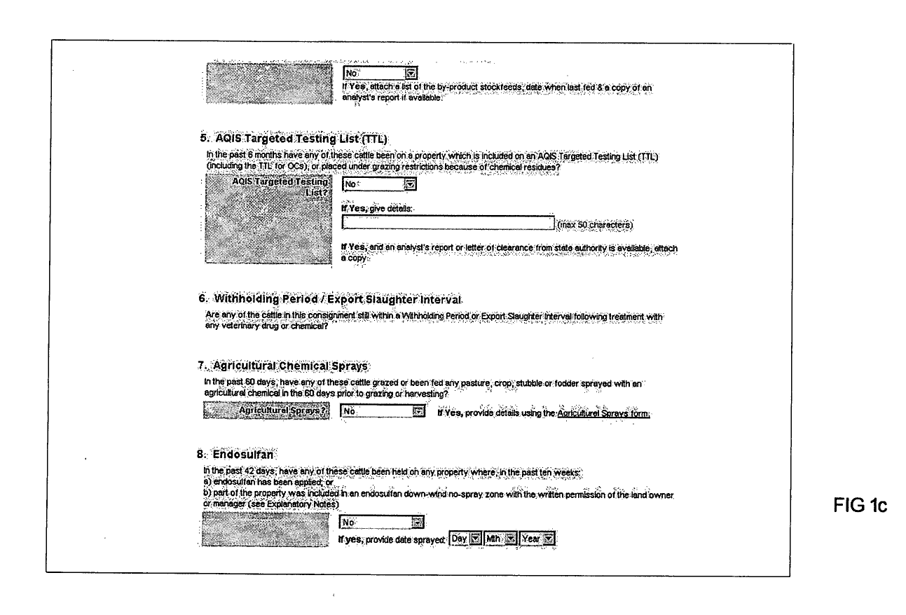

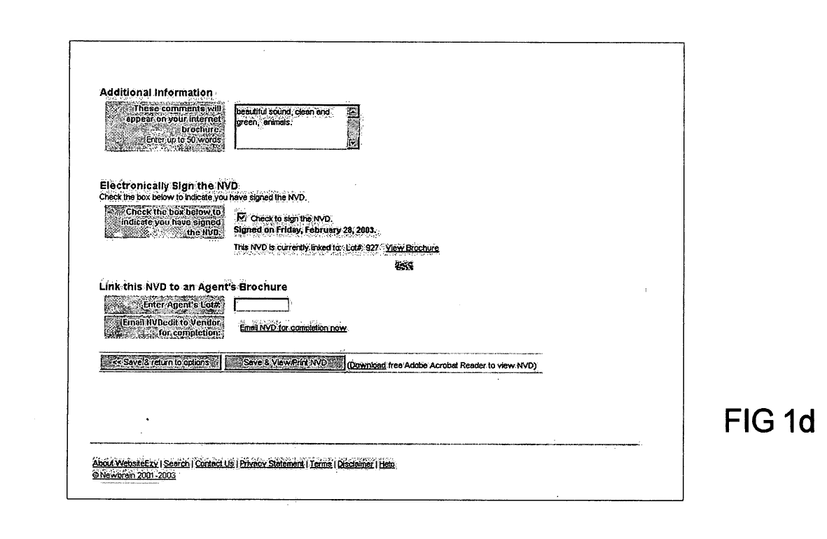

After the vendor has identified the livestock for which a vendor declaration will be prepared, the system generates a number of questions to be answered by the vendor. Screen captures of the system interrogating a vendor is illustrated in FIGS. 1A, 1B, 1C and 1D. These screen captures show a vendor being prompted to reveal information pertaining to cattle to being transferred. The Vendor may have the vendor declaration generated by the system mailed to a specific email address, if the vendor wishes to take advantage of this feature an email address should be entered into the system. The system elicits information as to the producer including their name, phone number, property name and property location. The animal or livestock details are then elicited, the type of information entered includes the sex and number of cattle being sold. The Vendor may also identify the cattle being sold by quoting their National Livestock Identification Scheme (NLIS) number, this provides identification of individual animals. The system then interrogates the user as to whether any of the animals have been treated with Hormonal Growth Promotant (HGP) or other chemicals.

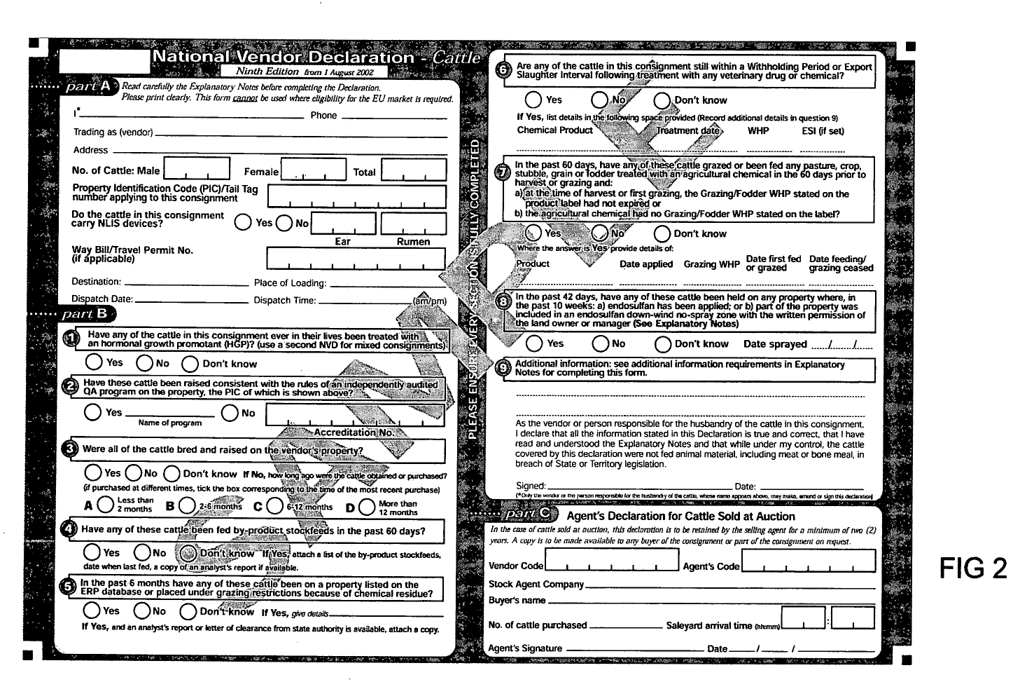

Additionally, the system may determine whether the livestock are quality assured. Cattle that have been continually raised on a property accredited under an independently audited quality assurance program may be more desirable to prospective purchasers and accordingly increase interest in the consignment. The system may also interrogate as to the history of the cattle thereby eliciting information such as where the animals are from and how long they have been owned by the vendor. Questions 3 to 8 on FIGS. 1B and 1C elicit information as to whether the livestock has been exposed to various chemicals. At FIG. 1D of the form there is illustrated a section which the vendor can enter information providing the vendor with an opportunity to make any comments and provide an electronic signature to the declaration If the vendor chooses to electronically sign and thereby warrant that the information provided is authentic then the system will verify the identity of the vendor and upon generation of the declaration it will be imprinted with an electronic signature signifying the vendors assurance that the information provided is true and correct. The system will then generate a vendor declaration containing within it the information provided by the vendor. A sample vendor declaration in the form of a National Vendor Declaration is shown in FIG. 2. This declaration is then posted to a pre-determined location either by emailing it to a location specified by the vendor or by posting it to a uniform resource locator (URL). Where the vendor declaration is posted to a URL the vendor can then include this URL in their promotional literature thereby providing the required information to prospective purchasers.

In one form of the invention the vendor declaration information may have modification suggested by the vendor's agent. To facilitate this, the agent establishes a connection to the transfer facilitator and provides a verification of identification to the system. The agent may then provide the system with information regarding the livestock sold or to be sold on behalf of the purchaser. This type of information may include the identity of the purchaser, the price of the livestock, the quality of product and any other comments the agent wishes to make. This information may be automatically incorporated by the system into the vendor declaration together with an electronic signature authenticating the information provided by the agent. Where this information is incorporated, the vendor may also be given an option to authorise such incorporation.

The present invention is also particularly applicable to the transfer of information relating to food products. These may be food products for animal or human consumption.

Where commodities such as fodder are sold it is necessary to provide detailed information pertaining to that fodder. This gives the purchaser assurance as to the quality of the fodder that they are receiving. It also acts as a safeguard to ensure that undesirable chemicals and poisons do not enter the food chain. Examples of the types of information which can be provided include:
(a) the chemicals applied to the crop from which the fodder was harvested. All chemicals and inputs applied to the crop from preparation of the seeding ground through seedling emergence should be listed together with the amount of chemical utilised. This allows a perspective purchaser to satisfy himself/herself that unwanted chemicals have not been used in the growing of the fodder;
(b) information pertaining to the nature of seed from which the crop was sown. For example, it may be undesirable to use a particular genetically modified seed. In receiving this information, the purchaser is therefore able to satisfy himself/herself that the fodder originates from the desire type of seed or alternatively, that the fodder does not originate from an undesirable source.
(c) information pertaining to all adjoining crops and the nature of these crops.

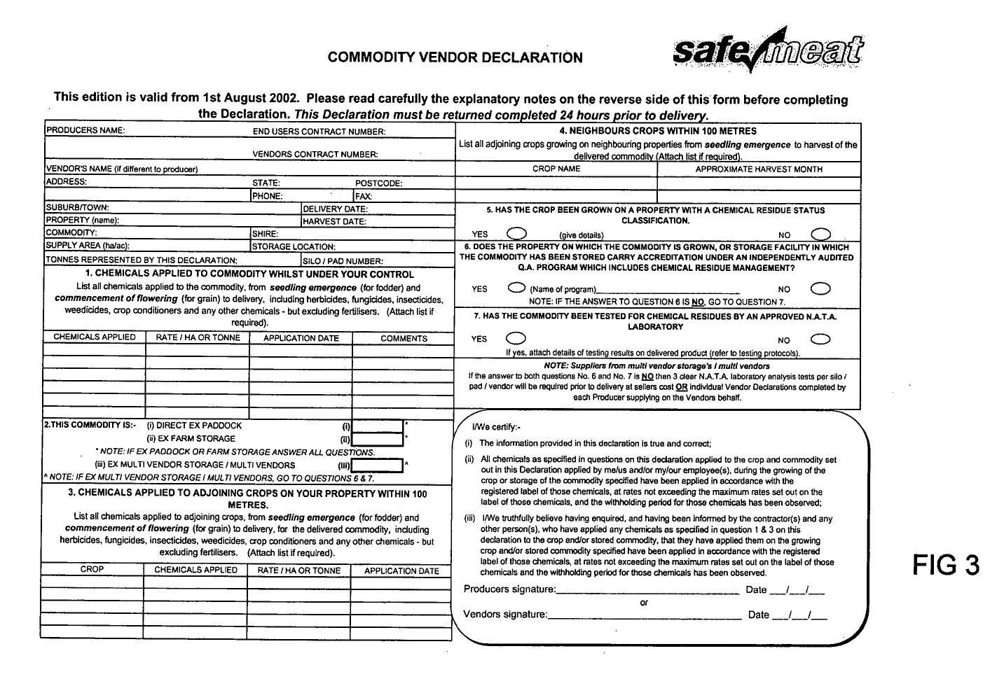

A sample declaration, which will be completed where fodder is supplied, is shown in FIG. 3. In response to prompts from the transfer facilitator, the food provider enters information pertaining to the particular commodity they wish to sell. The transfer facilitator then automatically places the information into the declaration and posts it to a point accessible by the food supplier and/or prospective purchasers.

It should be understood that the present invention is particularly useful to the transfer of information relating to food products. Where food products are supplied then it is important that the histories of those products are known all through the supply chain. The present invention allows for the collection of information pertaining to one or a number of steps along the food supply chain.

Reference to the word “site” within the specification should be taken as a reference to a point of presence located on a computer network. One example of a site being a web site located at a point on the Internet. It will however be understood that the present invention is not limited to utilisation of a site.

It is to be understood that various alterations, additions and/or modifications may be made to the parts previously described without departing from the ambit of the invention.

1-39. cancelled.

40. A method of utilising a computer network to facilitate the transfer of livestock from a vendor to a purchaser, the method including the steps:
(a) the vendor initiates a connection over the computer network between a computer associated with the vendor and a computer associated with a transfer facilitator;
(b) the transfer facilitator prompts the vendor for information pertaining to the consignment of livestock that the vendor proposes to transfer;
(c) in response to prompts from the transfer facilitator, the vendor provides the transfer facilitator with information regarding the livestock which the vendor proposes to transfer; and
(d) the transfer facilitator converts the information received from the vendor into a vendor declaration and posts the vendor declaration to a point on the computer network accessible by the vendor and/or one or more prospective purchasers.

41. A method according to claim 40, wherein the transfer facilitator is a transfer facilitation site located on the computer network.

42. A method according to claim 40, wherein at any time before posting of the vendor declaration, the transfer facilitator verifies the identity of the vendor and accordingly includes within the vendor declaration an electronic signature verifying authenticity of the declaration.

43. A method according to claim 40 wherein the vendor declaration is posted at a Uniform Resource Locator (URL) on the Internet and the URL is then be provided to one or more prospective purchasers.

44. A method according to claim 40 wherein the vendor declaration is posted onto a database accessible over the computer network, the database holding a plurality of vendor declarations.

45. A method according to claim 40 wherein the vendor declaration is posted by sending it via electronic mail to one or more of the following:
(a) the vendor;
(b) an agent of the vendor;
(c) one or more of the prospective purchasers;
(d) any relevant statutory authority and
(e) a pre-determined third party;

46. A method according to claim 40, including the steps:
(a) the vendor appoints a third party; and
(b) the transfer facilitator forwards to the third party, via the computer network, an electronic copy of the vendor declaration.

47. A method according to claim, including the steps:
(a) the vendor appoints a third party;
(b) the third party connects to the transfer facilitator via the computer network;
(c) the third party provides information regarding the livestock sold on behalf of the purchaser; and
(d) the transfer facilitator verifies the identity of the third party and upon verification, the vendor declaration is automatically modified to include information provided by the third party in the vendor declaration.

48. A method according to claim 40 wherein the vendor declaration contains one or more of the following types of information:
(a) whether the livestock have been exposed to pre-determined drugs or chemicals;
(b) information pertaining to any quality accreditation of a property on which the livestock has been raised;
(c) nature of any feed product provided to the livestock;
(d) details of the vendor;
(e) details of any agent appointed by the vendor; and
(f) details of any livestock assessors associated with the livestock.

49. A transfer facilitation system located on a computer network, the system provided to facilitate the transfer of livestock from a vendor to a purchaser, the system including the following components
(a) access means for allowing the vendor to access the system via 10 the computer network;
(b) means for interrogating the vendor to allow collection of information pertaining to the livestock that the vendor proposes to sell;
(c) conversion means for converting the information pertaining to the consignment of livestock, the information collected from the vendor and converted into a vendor declaration; and
(d) posting means for posting the vendor declaration to a point on the computer network accessible by one or more prospective purchasers.

50. A system according to claim 49 wherein the system includes:
(a) means to verify the identity of the vendor wherein the means to identify operates at any time before posting the vendor declaration; and
(b) means to modify the vendor declaration to include an electronic signature verifying authenticity of the vendor declaration, the means to modify operating after receiving notification from the means to verify that the vendor's identity has been verified.

51. A system according to claim 49 wherein the vendor declaration is posted at a Uniform Resource Locator (URL) on the Internet, and the URL is then provided to one or more prospective purchasers.

52. A system according to claim 49 wherein the system includes a database holding one or more of the vendor declarations, one or more of the declarations being posted onto the system by the posting means.

53. A system according to claim 49 wherein the posting means sends the vendor declaration via electronic mail to one or more of the following;
(a) the vendor;
(b) an agent of the vendor;
(c) one or more of the prospective purchasers; and
(d) any relevant statutory authority.

54. A system according to claim 49 wherein the posting means sends the vendor declaration to an agent appointed by the vendor, the system including:
(a) access means for allowing the agent to access the system via the computer network;
(b) means for interrogating the agent for information regarding the livestock sold on behalf of the purchaser; and
(c) agent verification means for verifying the identity of the agent;
(d) compilation means for automatically including information provided by the agent in the vendor declaration where the identity of the agent has been verified by the verification means.

55. A system according to claim 54 wherein the agent verification means includes an electronic signature on the vendor declaration verifying the information provided by the agent.

56. A system according to claim 49 wherein the vendor declaration contains one or more of the following types of information:
(a) whether the livestock have been exposed to pre-determined drugs or chemicals;
(b) information pertaining to any quality accreditation of a property on which the livestock has been raised;
(c) nature of any feed product provided to the livestock;
(d) number of livestock detailed in the vendor declaration;
(e) sex of the livestock detailed in the vendor declaration;
(f) location of the livestock detailed in the vendor declaration;
(g) details of the vendor;
(h) details of an agent appointed by the vendor; and
(i) details of any livestock assessor.

57. A system according to claim 49 including a search means for accessing and searching information pertaining to vendor declarations.

58. A method according to claim 40, wherein the transfer facilitator automatically crosschecks the information provided by the vendor.

59. A method according to claim 40, wherein at any time before posting the vendor declaration, the transfer facilitator verifies the identity of the vendor.

60. A method according to claim 59, wherein after verification of the identity of the vendor, an electronic signature verifying authenticity of the declaration is included together with or within the declaration.

61. A method of utilising a computer network to provide information pertaining to the suitability of livestock for consumption, the method including the steps of:
(a) a vendor initiates a connection over the computer network between a computer associated with the vendor and a computer associated with a transfer facilitator;
(b) the vendor provides the transfer facilitator with information regarding the livestock which the vendor proposes to sell; and
(c) the transfer facilitator automatically converts the information received from the vendor into a vendor declaration and posts the vendor declaration to a point on the computer network accessible by the vendor and/or one or more prospective purchasers.

62. A method of utilising a computer network to provide information pertaining to the suitability of food for consumption, the method including the steps of:
(a) a food provider initiates a connection over the computer network between a computer associated with the food provider and a computer associated with a transfer facilitator;
(b) the food provider enters information pertaining to food that the food provider intends to sell including information pertaining to the suitability of the food for consumption; and
(c) the transfer facilitator converts the information received from the food provider into a declaration and posts the declaration to a point on the computer network accessible by the food provider and/or one or more prospective purchasers.

63. A method of providing information pertaining to food over a computer network to facilitate the transfer of food from a food provider to a purchaser, the method including the steps:
(a) a food provider initiates a connection over the computer network between a computer associated with the food provider and a computer associated with a transfer facilitator;
(b) the food provider enters information pertaining to food that the food provider intends to transfer including information pertaining to the suitability of the food for consumption; and
(c) the transfer facilitator converts the information received from the food provider into a declaration and posts the declaration to a point on the computer network accessible by the food provider and/or one or more prospective purchasers.

64. A method according to claim 62, wherein the transfer facilitator crosschecks the information entered by the food provider to verify the information.

65. A method according to claim 62, wherein at any time before posting of the declaration, the transfer facilitator verifies the identity of the vendor.

66. A method according to claim 65, wherein after verification, an electronic signature is included with or within the declaration to verify its authenticity.

67. A method according to claim 62, wherein the declaration is posted to a database accessible over the computer network, the database holding a plurality of declarations.

68. A method according to claim 62, wherein the declaration contains one or more of the following types of information:
(a) whether the food has been exposed to pre-determined chemicals;
(b) information pertaining to the quality accreditation of a property from which the food originates; and
(c) information pertaining as to whether the food is genetically modified or originates from a genetically modified source.

69. A method according to claim 62, wherein the declaration is sent via electronic mail to one or more of (a) the food provider; (b) one or more prospective purchasers; (c) one or more agents and (d) a relevant statutory authority.

70. A food information system located on a computer network, the system provided to facilitate provision of information pertaining to food, the system including the following components:
(a) access means for allowing a food provider to access the system via the computer network;
(b) means for interrogating the food provider to allow collection of information pertaining to food which the food provider proposes to provide, the information including information pertaining to the suitability of the food for consumption;
(c) conversion means for converting the information pertaining to the food into a declaration; and
(d) posting means for posting the declaration to a point on the computer network accessible by one or more purchasers and/or the food provider.

71. A method according to claim 46, wherein the third party is one or more of:
(a) an agent commissioned to sell the livestock;
(b) a food assessor;
(c) a party providing transport for the livestock;
(d) a processor;
(e) a market alliance of the purchaser; and
(f) a vet.

72. A method according to claim 47, wherein the vendor accepts or rejects information provided by the third party.

73. A method according to claim 61, wherein the transfer facilitator verifies that the declaration is complete.

74. A method according to claim 61, including the additional steps:
(a) the vendor nominates a third party;
(b) the third party connects to the transfer facilitator via the computer network;
(c) the third party provides information regarding the food; and
(d) the transfer facilitator verifies the identity of the third party and upon verification, the declaration is modified to include information provided by the third party.

75. A method according to claim 74, wherein the vendor reviews information provided by the third party and authorises that that information be included within the declaration.

76. A method according to claim 61, wherein one or more persons connect to the transfer facilitator to authorise the declaration.
